(19) United States
(12) Patent Application Publication
(10) Pub. No.: US 2010/0143054 A1
(43) Pub. Date: Jun. 10, 2010

(54) METHOD OF MACHINING A WORKPIECE

(76) Inventors: Cornelius Johannes Pretorius, Clare (IE); Peter Michael Harden, Limerick (IE)

Correspondence Address: FROMMER LAWRENCE & HAUG, 745 FIFTH AVENUE- 10TH FL., NEW YORK, NY, 10151, US

(21) Appl. No.: 12/527,526

(22) PCT Filed: Feb. 28, 2008
(86) PCT No.: PCT/IB08/50714

§ 371 Date: Feb. 19, 2010

(30) Foreign Application Priority Data
Feb. 28, 2007 (ZA) 2007/01779
Feb. 28, 2007 (ZA) 2007/01780

(51) Int. Cl. B23B 3/00; B26D 1/00; B23B 35/00; B23C 1/00

(52) U.S. Cl. 408/1 R; 83/13; 82/1.11; 409/131; 144/329

(57) ABSTRACT

The invention provides for a method of machining a workpiece made of a material selected from a metal, metal matrix composite, wood, synthetic, ceramic and stone and synthetic construction materials which includes the step of machining the workpiece using a tool which includes a tool component comprising a layer of polycrystalline diamond (12) having a working surface (16), a softer layer (20) containing a metal and bonded to the working surface (16) of the polycrystalline diamond layer (12) along an interface, the region (22) of the layer of polycrystalline diamond (12) adjacent the interface containing some metal from the softer layer (20).

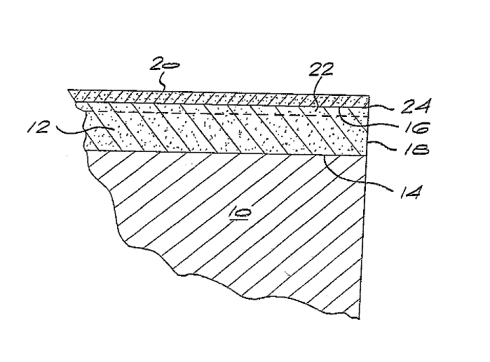

### BACKGROUND OF THE INVENTION

This invention relates to a method of machining a workpiece.

Ultra-hard abrasive cutting elements or tool components utilizing diamond compacts, also known as polycrystalline diamond (PCD), and cubic boron nitride compacts, also known as PCBN, are extensively used in drilling, milling, cutting and other such abrasive applications. The element or tool component will generally comprise a layer of PCD or PCBN bonded to a support, generally a cemented carbide support. The PCD or PCBN layer may present a sharp cutting edge or point or a cutting or abrasive surface.

PCD comprises a mass of diamond particles containing a substantial amount of direct diamond-to-diamond bonding. PCD will typically have a second phase containing a diamond catalyst/solvent such as cobalt, nickel, iron or an alloy containing one or more such metals. PCBN will generally also contain a bonding phase which is typically a cBN catalyst or contain such a catalyst. Examples of suitable bonding phases are aluminium, alkali metals, cobalt, nickel, tungsten and the like.

PCD cutting elements are widely used for machining a range of metals and alloys as well as wood composite materials. The automotive, aerospace and woodworking industries in particular use PCD to benefit from the higher levels of productivity, precision and consistency it provides. Aluminium alloys, bi-metals, copper alloys, carbon/graphite reinforced plastics and metal matrix composites are typical materials machined with PCD in the metalworking industry. Laminated flooring boards, cement boards, chipboard, particle board and plywood are examples of wood products in this class. PCD is also used as inserts for drill bodies in the oil drilling industry.

Components for automotive, aerospace, construction and general engineering industries typically require substantial machining so as to achieve the required form accuracy and surface integrity required to make them fit for their intended purpose. With advances in modern machine tools, the cutting tool has become the most critical factor affecting work piece quality and process efficiency.

Typical work piece materials fabricated using cutting tools include metals, both ferrous and non-ferrous, alloys and superalloys thereof, metal matrix composites, stone and synthetic construction materials including concrete and cement, wood materials including natural woods, chip board, particle and fibre boards, laminated boards, and synthetic composites including plastics, glass and carbon fibre reinforced plastics, and ceramics.

Typical fabrication operations undertaken on workpieces using cutting tools include sawing, cutting, milling, turning and drilling. Typically, these operations can be classified by the degree of interrupt experienced by the tool in the machining operation. For example, in a turning operation the cutting element of the tool is in continuous contact with the workpiece throughout the machining operation. In contrast, in a milling operation, one or more cutting elements come into intermittent contact with the workpiece throughout the machining operation.

A demand for enhanced performance from fabricated components in general has lead to the development of more sophisticated workpieces that are inherently more difficult to machine, in continuous machining processes but particularly in interrupted cutting processes where the cutting element is subject to cyclical thermal and mechanical loading. In addition, there is a demand for greater efficiencies in machining operations which are typically achieved through higher material removal rates that also generate increased thermal and mechanical loading on the cutting tool.

To meet the evolving needs of the construction and manufacturing industries, therefore, cutting tools must be developed which provide not only extreme wear resistance but also enhanced toughness.

U.S. Pat. No. 3,745,623 discloses the manufacture of PCD in a titanium or zirconium protective sheath, some of which is converted to carbide during manufacture. A thin layer of this titanium or zirconium sheath may be left on the PCD over the chip breaker face.

### SUMMARY OF THE INVENTION

The invention provides a method of machining a workpiece made of a material selected from a metal, metal matrix composite, wood, synthetic, ceramic, stone and synthetic construction materials which includes the step of machining the workpiece using a tool which includes a tool component comprising a layer of polycrystalline diamond having a working surface, a softer layer containing a metal and bonded to the working surface of the polycrystalline diamond layer along an interface and the region of the layer of polycrystalline diamond adjacent the interface containing some metal from the softer layer.

The softer layer provides a layer softer than the polycrystalline diamond for the tool component. This softer layer is strongly bonded to the working surface of the polycrystalline by virtue of the fact that some of the metal has diffused into the region of the polycrystalline diamond adjacent the interface with the softer layer and is present in this region of the polycrystalline diamond. Some of the metal present as a second phase in the polycrystalline diamond will also have diffused into the softer layer. Thus, the bond between the softer layer and the polycrystalline diamond is, in essence, a diffusion bond. Such a bond may be produced, for example, during the manufacture of the polycrystalline diamond, i.e. the softer layer is created and bonded to the polycrystalline diamond in situ during such manufacture.

It has been found that the provision of a softer layer on the working surface of the polycrystalline diamond material improves the performance of the tool component in applications where chip resistance is a critical tool material requirement and where a cutting tool is required to provide not only extreme wear resistance, but also enhanced toughness. Thus, the invention provides improved machining of a variety of workpieces using such a tool component. Machining of a workpiece, as is known in the art, involves moving the workpiece and cutting edge or point of a cutting component in a tool relative to each other and advancing the cutting edge or point into the workpiece. Examples of machining operations are sawing, cutting, milling, turning and drilling.

Typical work piece materials which can be machined in the method of the invention are metals, both ferrous and non-ferrous, alloys and super alloys thereof, metal matrix composites, stone and synthetic construction materials including concrete and cement, wood materials including natural woods, chip board, particle and fibre boards, laminated boards, and synthetic composites including plastics, glass and carbon fibre reinforced plastics, and ceramics. Other applications include milling, sawing and reaming of composites (including wood), aluminium-alloys, cast irons, titanium alloys, heat resistant superalloys (HRSA) and hardened steels.

The metal of the softer layer may be any one of a variety of metals, but is preferably a transition metal. Examples of suitable transition metals are molybdenum, niobium, tantalum, titanium and tungsten. Nickel is also believed to be a particularly suitable metal for the practice of the invention.

The metal of the softer layer may be present as metal, metal carbide, nitride, boride, silicide or carbonitride or a combination of two or more thereof. The metal of the softer layer is preferably present as metal, metal carbide or a combination thereof. More preferably, the softer layer consists predominantly of a metal in carbide form and a minor amount of the metal, as metal, and metal from the polycrystalline diamond, i.e. metal such as cobalt which is present as a second phase in the polycrystalline diamond. The softer layer may extend across a portion of the working surface only or across the entire working surface.

The working surface of the polycrystalline diamond layer is preferably the top surface of such layer and intersects another surface of the layer defining a cutting point or edge at the intersection. The softer layer preferably extends from the cutting edge or point across at least a portion of the working surface.

The thickness of the softer layer will vary according to the nature of the machining operation being carried out and the nature of the workpiece material. Generally, the softer layer has a thickness of up to 100 microns. The softer layer preferably has a thickness of at least 50 microns.

The softer layer bonded to the working surface of the polycrystalline diamond layer in the tool component of the invention may be produced in situ in the manufacture of the tool component. In such a method, the components for producing the polycrystalline diamond layer are placed in a metal cup or capsule which is then subjected to the conditions of elevated temperature and pressure required to produce the polycrystalline diamond. Some of this metal cup or capsule adheres to and bonds to the outer surface of the polycrystalline diamond during manufacture. Alternatively a layer of the metal which is intended to form the softer layer may be placed in contact with the unbonded diamond particles in the capsule or cup. Some of the metal from the capsule, cup or layer will diffuse into the polycrystalline diamond, during manufacture. Similarly, some metal from the polycrystalline diamond, e.g. cobalt, will diffuse into the softer layer.

The working surface of the diamond layer may be smooth, polished or rough or irregular. When the working surface is rough or irregular, such may be that resulting from subjecting the working surface to a sandblasting or similar process.

The top, exposed surface of the softer layer may be polished. Polishing the softer layer is obviously considerably easier than polishing a surface of the polycrystalline diamond layer.

The layer of polycrystalline diamond is preferably bonded to a substrate or support, generally along a surface opposite to that of the working surface. The carbide is preferably tungsten carbide, tantalum carbide, titanium carbide or niobium carbide. Ultra-fine carbide is preferably used in making the cemented carbide by methods known in the art.

### BRIEF DESCRIPTION OF THE DRAWING

The drawing is a sectional side view of a portion of an embodiment of a tool component for use in the method of the invention.

### DESCRIPTION OF PREFERRED EMBODIMENTS

The invention thus provides the use of a tool component with improved performance in applications where chip resistance is a critical tool material requirement. Other advantages which flow from the nature of the softer layer and its strong bond with the polycrystalline diamond layer in the various machining operations of the invention are:

A softer layer bonded to the harder abrasive layer results in a self-rounding or self-honing effect of the cutting edge in the initial stages of wear. This in turn will increase the strength of the cutting edge and reduce the break-in wear stage. The degree of rounding can be controlled by either increasing or decreasing the hardness of the softer layer. The material of the layer will also fill the pores and pits at the edge of the polycrystalline diamond layer resulting in less wear initiation sites. After the initial rounding process, the softer top layer can wear into the shape of a chip breaker.

A polished softer top layer will result in fewer flaws on the working surface as compared to prior art polycrystalline diamond products. The softer layer will also deform quickly to provide a stronger more rounded edge during the initial stages of cutting. Metal layers will generally also have a higher fracture toughness as compared to polycrystalline diamond. A less aggressive polishing method will result in lower stresses in the polycrystalline diamond surface. All these factors will reduce the frequency and severity of spalling, chipping and cracking, particularly in interrupted and/or impact machining of substrates.

An embodiment of a tool component for use in the method of the invention will now be described with reference to the accompanying drawing which illustrates the cutting edge portion of a tool component. Referring to this drawing, a tool component comprises a cemented carbide substrate 10 to which is bonded a layer of polycrystalline diamond 12 along interface 14. The layer of polycrystalline diamond 12 has an upper surface 16 which is the working surface of the tool component. The surface 16 intersects side surface 18 along a line 24 which defines a cutting edge for the tool component.

A softer layer 20 is bonded to the working surface 16. This softer layer 20 extends to the cutting edge 24. The softer layer 20 is of the type described above and contains a metal. Some of this metal from the layer 20 will be present in the region 22 in the polycrystalline diamond layer indicated by the dotted lines. Some metal from the polycrystalline diamond layer 12 will be present in the softer layer 20. Thus, a diffusion bond exists between the softer layer 20 and the polycrystalline diamond layer 12.

Examples of tool components for use in the method of the invention will now be described.

### Example 1

A mass of diamond particles was placed on a surface of a cemented carbide substrate having cobalt as the binder phase. This unbonded mass was placed in a molybdenum capsule and this capsule placed in the reaction zone of a conventional high pressure/high temperature apparatus. The contents of the capsule were subjected to a temperature of about 1400° C. and a pressure of about 5 GPa. These conditions were maintained for a time sufficient to produce a layer of polycrystalline diamond having a surface bonded to the cemented carbide substrate and an opposite exposed surface. The layer of polycrystalline diamond had a second phase containing cobalt.

The capsule was removed from the reaction zone. A layer of molybdenum/molybdenum carbide was bonded to the outer surface of the polycrystalline diamond. The outer regions of this layer of molybdenum/molybdenum carbide were removed by grinding leaving a thin layer of a material softer than the polycrystalline diamond bonded to one of the major surfaces of the layer of polycrystalline diamond.

The softer layer had a thickness of 100 microns. Analysis using EDS showed that this softer layer consisted predominantly of molybdenum carbide and a minor amount of molybdenum metal and cobalt from the cemented carbide substrate. The region of the polycrystalline diamond adjacent the interface with the softer layer was found to contain molybdenum, using the same EDS analysis. The bond between the softer layer and the polycrystalline diamond layer was strong. A plurality of cutting tool components were produced from the carbide supported polycrystalline diamond, such cutting tool inserts having a structure as illustrated by the accompanying drawing. These cutting tool components were found in tests to be effective in wood working and metal working applications. No delamination of the softer layers occurred.

### Example 2

A carbide supported polycrystalline diamond product comprising a layer of polycrystalline diamond bonded to a cemented carbide substrate and having a softer layer consisting predominantly of niobium carbide and a minor amount of niobium, as metal, and cobalt from the polycrystalline diamond was produced in the same manner as in Example 1, save that a niobium capsule was used instead of the molybdenum capsule. A minor amount of niobium was found to be present in the region of the polycrystalline diamond adjacent the interface with the softer layer. The thickness of the softer layer was 100 microns. From this product a plurality of tool components, each having a structure illustrated by the drawing and suitable for drilling applications were produced.

1. A method of machining a workpiece made of a material selected from a metal, metal matrix composite, wood, synthetic, ceramic and stone and synthetic construction materials includes the step of machining the workpiece using a tool which includes a tool component comprising a layer of polycrystalline diamond having a working surface, a softer layer containing a metal and bonded to the working surface of the polycrystalline diamond layer along an interface, the region of the layer of polycrystalline diamond adjacent the interface containing some metal from the softer layer.

2. A method according to claim 1 wherein the metal of the softer layer is a transition metal.

3. A method according to claim 1 wherein the metal of the softer layer is present as metal, metal carbide, nitride, boride, silicide or carbonitride or a combination of two or more thereof.

4. A method according to claim 1 wherein the softer layer consists predominantly of the metal in the form of the carbide and a minor amount of the metal, in metal form, and metal from the polycrystalline diamond.

5. A method according to claim 1 wherein the metal is selected from molybdenum, niobium, tantalum, titanium and tungsten.

6. A method according to claim 1 wherein the softer layer has a thickness of up to 100 microns.

7. A method according to claim 1 wherein the softer layer covers a portion of the working surface only.

8. A method according to claim 1 wherein the softer layer covers the entire working surface.

9. A method according to claim 1 wherein the working surface is a top surface of the layer of polycrystalline diamond which intersects a side surface defining a cutting edge for the tool component at the intersection.

10. A method according to claim 9 wherein the softer layer extends from the cutting edge across at least a portion of the working surface.

11. A method according to claim 1 wherein the softer layer has a thickness of at least 50 microns.

12. A method according to claim 1 wherein the layer of polycrystalline diamond is bonded to a substrate.

13. A method according to claim 12 wherein the substrate is a cemented carbide substrate.

14. A method according to claim 1 wherein the machining is sawing, cutting, milling, turning or drilling.

15. A method according to claim 1 wherein the workpiece is a metal material selected from ferrous metals, non-ferrous metals, alloys and superalloys thereof.

16. A method according to claim 1 wherein the workpiece is a synthetic construction material selected from concrete and cement.

17. A method according to claim 1 wherein the workpiece is a wood material selected from natural woods, chip board, particle and fibre boards, and laminated boards.

18. A method according to claim 1 wherein the workpiece is a synthetic composite selected from plastics, glass and carbon fibre reinforced plastics.

19. (canceled)

20. (canceled)

21. A method according to claim 2 wherein the metal of the softer layer is present as metal, metal carbide, nitride, boride, silicide or carbonitride or a combination of two or more thereof.
